(19) United States
(12) Patent Application Publication
(10) Pub. No.: US 2005/0216324 A1
(43) Pub. Date: Sep. 29, 2005

(54) System and method for constructing a schedule that better achieves one or more business goals

(75) Inventors: Ravi Maithell, Saskatoon (CA); Joe Zhou, Saskatoon (CA); Adam McKee, Saskatoon (CA); Yin Zhou, Saskatoon (CA); Howard Lee, Saskatoon (CA); Trent McConaghy, Saskatoon (CA)

Correspondence Address: NIXON & VANDERHYE, PC, 901 NORTH GLEBE ROAD, 11TH FLOOR, ARLINGTON, VA, 22203, US

(73) Assignee: Clevor Technologies Inc., Saskatoon (CA)

(21) Appl. No.: 11/052,883

(22) Filed: Feb. 9, 2005

(30) Foreign Application Priority Data
Mar. 24, 2004 (CA) 2,461,808

(51) Int. Cl. G06F 17/60

(52) U.S. Cl. 705/8

(57) ABSTRACT

A system and method for constructing a schedule that better achieves one or more business goals by generating a schedule optimized for at least one business goal comprising either a business objective or a business constraint. The present system and method, in addition to using information about the set of tasks, any information about constraints about the tasks, the available resources, the time to complete the tasks, all costs and any additional information in relation to the available resources, the present method, also uses information about the costs associated with the project, the sales revenues or fees earned by the project, customer satisfaction and alternative resources, in order to generate an optimized schedule meeting one or more defined business goals.

This invention is in the field of scheduling and scheduling software.

### BACKGROUND

Scheduling is a business process required in many diverse industries as well as in non-business operations such as government and cultural operations. Scheduling is used both by those organizations that have project oriented work as well as those in the manufacturing industry. Some industries and organizations that rely heavily on scheduling are: the construction industry, large or small organizations involved in completing different projects for customers, the manufacturing industry, the airline industry in their scheduling of flights and other operations, the space industry, especially in their allocation of satellites to specific orbits, running a cafeteria or hospital, and the military. Typically, a wide scope of business or companies are involved with scheduling at any given time and proper scheduling or better scheduling can result in a huge competitive advantage for a company.

Developing a schedule for a project or group of projects is a very complex task. Scheduling problems involve many different variables and there could typically be numerous different schedules that can be used to complete a project. If the project is complex or if there are multiple projects to schedule, there may be a huge number of feasible schedules that will complete the project or projects, while observing all the specified constraints. Because of all the variables present in any scheduling problem, the problem of scheduling and determining a schedule that is simply feasible can be very complex and non-linear.

Traditionally, schedules were constructed manually. Simply put, a person sat down with the projects or projects that needed to be scheduled and manually broke it down into the set of tasks necessary to complete the project and determining any constraining factors on these task including the resources necessary to complete each of the tasks. Often with a complex problem it might be almost impossible or just sheer luck to come up with a feasible schedule. This first schedule might then be manually adjusted by adding resources to attempt to reduce the time taken to complete a project.

The problems with manually scheduling is that it is very time consuming, does not usually result in any sort of “optimal” solution and in many cases the project or projects might be too complex to find a feasible scheduling solution manually.

This traditional method was improved slightly by the use of computers to aid in scheduling. Originally, computers only took the place of some of the mental calculations in the scheduling process leaving the person doing the scheduling to still determine manually which resources to increase or decrease or manually alter other variables to fine tune the schedule and attempt to improve it.

Still more recent improvements in computer scheduling involve the use of Enterprise Resource Planning (ERP) Systems to manage information about their operations. Most of these systems build schedules using either forward scheduling rules or backward scheduling rules. When forward scheduling rules are used, the scheduler will stack defined projects in the order of priority given to them by the user. After that, the scheduler will schedule one project at a time taking into account all of the constraints associated with the tasks and the resources necessary to complete it. The overall concept is simple taking the tasks of the project and scheduling them one by one with the resource it is based on, while observing all the constraints associated with the task and associated resources. Backward scheduling operates on a similar principle except that it starts at the end of the schedule and moves forward from the due dates of the projects.

The result of the ERP systems is an adequate schedule in the sense that it is feasible and should satisfy all of the defined constraints. However, while it is feasible, it is hardly an optimal schedule. Some ERP systems allow a low-level of “optimizing” to be achieved by including a scheduling window that allows a user to drag and drop capabilities of the schedule to attempt to improve the schedule.

More recently, scheduling programs have allowed for the optimization of schedules. New theories and practices, algorithms and tools, such as genetic algorithms, and the increase in computer capabilities have allowed modem scheduling programs to generate large numbers of feasible schedules in relatively short periods of time leading to the development of programs that allow a schedule to be optimized. This has allowed schedules to be improved above and beyond being merely feasible.

Traditionally, and still the rule today, schedules are constructed so that a project is completed on time and on budget. Typically, these scheduling systems attempt to optimize the schedule with goals such as one of the following operational objectives: throughput and makespan (the total time taken for completing all the projects) related objectives like minimize makespan; due date related objectives like minimize the lateness; set up cost related objectives like minimize the set up costs; work-in-process inventory costs related objects like minimize work-in-process inventory costs; finished goods inventory costs related objects like minimize finished goods inventory costs and labour costs related objectives like minimize the labour costs. The theory accompanying this practice is an underlying belief that all things being equal, optimizing such goals will result in the best schedule. The problem is that these goals may be not be the best in a business sense.

The true goals of a business are typically money-oriented, such as maximizing profitability (maximizing revenue, minimizing cost), maximizing revenue growth and maximizing customer satisfaction. Measures of a business' goals are a direct function of revenue and costs for the projects. If the business' highest-level goals were operational goals, such as doing things as fast as possible, use as many resources at their disposal or use only the cheapest resources they have access to, those goals may conflict with the business' true goals such as profitability.

The main problem with the prior art scheduling software is that operational goals and not business goals are directly optimized; the results of the optimization can conflict with the true business goals. For example, these programs often work on the assumption that the schedule that is completed in the shortest time will directly result in the schedule that will yield the highest profit from the project. This is not usually the case and often these schedules do not result in the final results the program is hoping to achieve.

Another problem that the prior art suffers from is that each of the tasks is assigned a resource (generally, the resource that will minimize the cost of that task) thereby restricting the opportunity to build a schedule that optimizes the business goal or business goals.

### SUMMARY OF THE INVENTION

It is the object of the present invention to provide a method of building a schedule that overcomes problems in the prior art. It's a further objective of the present invention to provide a method that is able to build a schedule that optimizes a business goal rather than an operational goal that it is hoped will affect the company's business objectives. It is a further objective of the present invention to provide a method of building a schedule that optimizes multiple defined business goals. It is a further object of the present invention to provide a system that can build an optimized schedule taking into account all the available resources that can be used to complete a task.

It is a further object of the invention to provide a method that can be implemented by a computer system that can optimize a schedule based on a company's business goals.

In one embodiment, the invention is a method of building a schedule to complete at least one project, the schedule being optimized for a business goal and comprising: breaking down the at least one project into a set of tasks and for each task defining any fixed costs, any additional information and any constraints associated with the task; for each task, identifying and defining a resource capable of completing the task and for each resource defining the time to complete the task using the resource, any costs associated with the resource and any additional information associated with each resource; defining at least one business goal; generating a set of schedules containing at least one schedule, the set of schedules being feasible based on any additional information and any constraints defined for each task and any additional information associated with each resource; calculating the value of the at least one business goal for each schedule in the set of schedules and determining the schedule with the best value for the at least one business goal in the set of schedules; and returning the schedule with the best value for the at least one business goal.

In another embodiment, the invention is a method for determining a schedule to complete at least one project, the schedule being optimized for a goal and comprising: breaking down the project into a set of tasks and for each task defining any fixed costs, any additional information and any constraints associated with the task; identifying and defining, for each of the tasks, a first resource able to complete the task and for each first resource defining the time to complete the task using the first resource, any costs associated with the first resource and any additional information associated with the first resource; identifying and defining, for at least one of the tasks, a second resource capable of completing the at least one of the tasks and for the second resource defining the time to complete the at least one of the tasks using the second resource, any costs associated with the second resource and any additional information associated with the second resource; defining at least one goal; generating a set of schedules containing at least one schedule, the set of schedules being feasible and each schedule comprising the set of tasks which comprises the at least one task associated with either the first resource or the second resource; calculating the value of the at least one goal for each schedule in the set of schedules and determining the schedule with the best value for the at least one goal in the set of schedules; and returning the schedule with the best value of the at least one goal.

In another embodiment, the invention is a method for determining a schedule to complete at least one project, the schedule being optimized for a goal and comprising: breaking down the project into a set of tasks and for each task defining any fixed costs, any additional information and any constraints associated with the task; identifying and defining, for each of the tasks, a resource able to complete the task and for each first resource defining the time to complete the task using the first resource, any costs associated with the first resource and any additional information associated with the first resource; identifying and defining, for at least one of the tasks, a maximum number of a resource capable of completing the at least one of the tasks and a minimum number of the resource and defining the time to complete the at least one of the tasks using the different number of available resources, any costs associated with the second resource and any additional information associated with the second resource; defining at least one goal; generating a set of schedules containing at least one schedule, the set of schedules being feasible and each schedule comprising the set of tasks which comprises the at least one task associated with either the first resource or the second resource; calculating the value of the at least one goal for each schedule in the set of schedules and determining the schedule with the best value for the at least one goal in the set of schedules; and returning the schedule with the best value of the at least one goal.

In another embodiment, the invention is a computer system for creating a schedule to complete at least one project, the schedule being optimized for a business goal and comprising: a processing unit; a memory storage device operatively connected to the processing unit; an input device operatively connected to the processing unit wherein the input device is operative to transmit information to the processing unit; a display device operative for displaying data and operatively connected to the processing unit; and a program module stored in the memory storage device operative for providing instructions to the processing unit, the processing unit responsive to the instructions of the program module, the program module operative for: receiving, from the input device, input information comprising; a set of tasks necessary to complete at least one project and for each of the tasks any fixed costs, any additional information and any constraints associated with the task; the resources necessary to complete each task and for each resource the time to complete the task using the resource, any costs associated with the resource and any additional information associated with the resource; at least one business goal; generating a set of schedules containing at least one schedule, the set of schedules being feasible, based on any additional information and any constraints defined for each project task and any additional information associated with each resources calculating the value of the at least one business goal for each schedule in the set of schedules and determining the schedule with the best value for the at least one business objective in the set of schedules; and returning the schedule with the best value for the at least one business objective.

The present invention provides in one embodiment a method that is implemented on a computer and can optimize a schedule based on a business goal consisting of at least one business objective or business constraint. In addition to using information about the set of tasks, any information about constraints about the tasks, the available resources, the time to complete the tasks and any additional information in relation to the available resources, the present method also uses information about the costs associated with the project and the sales revenues earned by the project. By defining the costs and sales revenues associates with a project, schedules can be optimized for a business objective that can be assigned a value based on these costs. Because of the information used in the method in relation to costs, numerous schedules can be generated and evaluated using the defined cost information or sales revenues to optimize the schedule for a business objective.

Rather than relying on what is perceived to be a relationship between variables in the schedule such as resource utilization or time to complete a project and a company's business goal, the present invention allows the definition of additional information, such as cost information or sales revenues earned that allows the schedule to be optimized for a business objective directly, such as maximum sales, maximum profit or minimum total cost. The result is business objectives of a company can be directly optimized using the invention rather than relying on a perceived relationship that is often tentatively related to the business objective at best.

In another embodiment tasks are defined such that they are not constrained to a single resource allowing the method to build a schedule for optimizing a defined business objective taking into account the different resources and different number of resources that can be used to complete tasks that make up the project.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a block diagram of a conventional computer system suitable for supporting the operation of the method of the present invention.

FIG. 2 is a schematic of method as contemplated by the present invention;

FIG. 3 is a flow chart of the steps of identifying and defining the project tasks;

FIG. 4 is a flow chart of the steps of identifying and defining the resources;

FIG. 5 is a flow chart of one embodiment of the process of optimizing a schedule using a single business goal where that business goal comprises a business objective;

FIG. 6 is a flow chart of a second embodiment of the process of optimizing a schedule using multiple goals where the business goal has at least one business objective;

FIG. 7 is a flow chart of another embodiment of the process of optimizing a schedule using business goal that comprises one business constraint;

FIG. 8 is a flow chart of another embodiment of the process of optimizing a schedule using a business goal wherein the business goal comprises one business constraint and there is a second constraint, which may be either a business constraint or an operational constraint.

FIG. 9 is a flow chart of another embodiment of the process of optimizing a schedule using a business goal and at least one constraint and an objective is defined; and

FIG. 10 is a flow chart of another embodiment of the process of optimizing a schedule using a business goal and at least one constraint and multiple objectives are defined.

### DETAILED DESCRIPTION OF THE ILLUSTRATED EMBODIMENTS

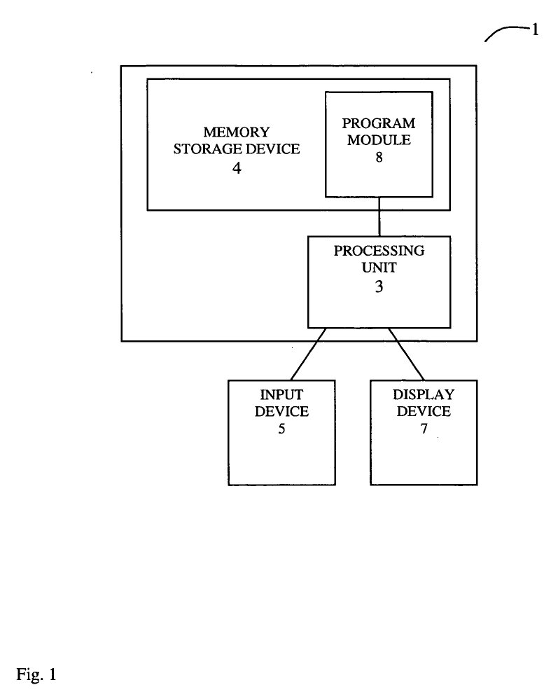

FIG. 1 illustrates a conventional computer system 1 suitable for supporting the operation of the method of the present invention. The conventional computer system 1 typically comprises: a processing unit 3; a memory storage device 4; an input device 5; a display device 7; and a program module 8.

The processing unit 3 can be any processing unit that is typically known in the art with the capacity to run the program and is operatively connected to the memory storage device 4 such as a local hard-disk, etc. The input device 5 can be any suitable device suitable for inputting data into the computer system 1, such as a keyboard, mouse or data port such as a network connection and is coupled to the processing unit 3 and operative to allow the processing unit 3 to receive information from the input device 5. The display device 7 can be any suitable device coupled to the processing unit 3 and operative for displaying data. The program module 8 is stored in the memory storage device 4 and operative to provide instructions to processing unit 3 and the processing unit 3 responsive to the instructions of the program module 8.

Although other internal components of a computer system 1 are not illustrated, those of ordinary skill in the art will appreciate that many more components and interconnections between them are well known and can be used. As well the computer system 1 need not be limited to only one computer system and may comprise a network of connected computer systems.

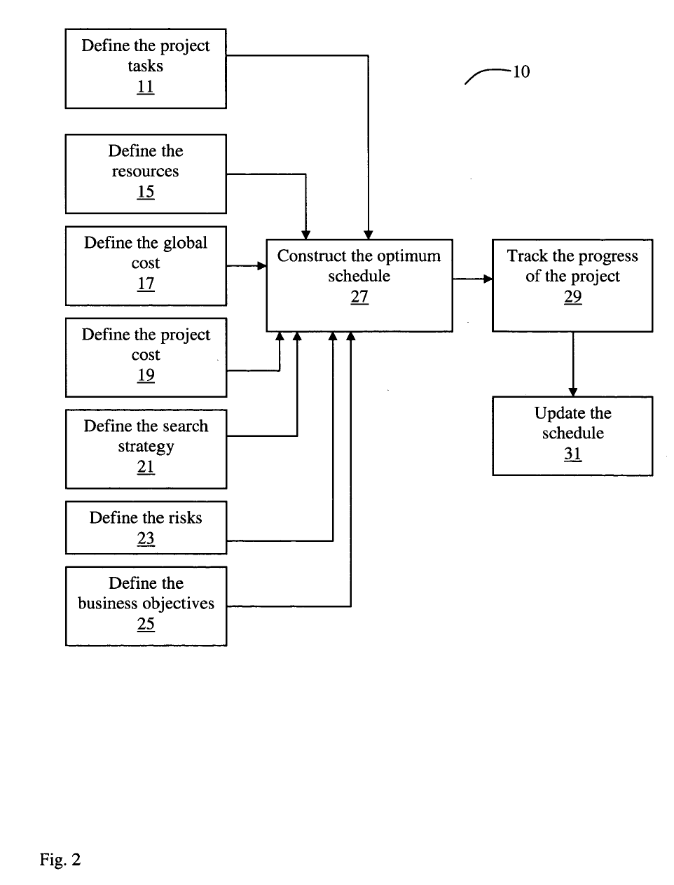

FIG. 2 is a flow chart illustrating the steps in the scheduling method 10 that may be implemented by the computer system 1 illustrated in FIG. 1. This method 10 comprises the steps of defining the project tasks 11, defining the resources 15, defining the global costs 17, the project costs 19, defining the search strategy 21, defining the risks 23, defining the business goal or business goals 25, constructing an optimized schedule 27, tracking the project progress 29 and updating the schedule 31.

Project/Work Order

Although the term “project” is used throughout the description it is readily apparent to someone skilled in the art that the term project could have a broad scope. A project is an endeavor, work or product that has a specific scope and objective. In the manufacturing industry, the terms “customer order” or “work order” are often used in place of project for the purposes of scheduling and the project is to manufacture a product or a batch of products or ship a batch of products. Also, in manufacturing the product or project could consists of a number of sub-assemblies, parts or materials defined by a bill of materials, a bill of manufacturing or a recipe. This bill of materials or recipe would in turn consist of operations, activities or tasks required to complete the sub-assemblies.

It is also contemplated that multiple projects or products could be incorporated into one schedule using the method outlined herein. Scheduling for multiple projects allows all of the projects to be undertaken to be accommodated in one schedule and can yield better result than only evaluating the results of scheduling of a single project. In the case where a manufacturing system producing multiple copies of a product is to be scheduled, basing the schedule on all of the products to be produced can allow the program to take into account the sale price of each product in relation to the time and number of products that can be produced.

Task/Operations

Defining the project tasks and their resource requirements 11 involves breaking down each of the project or projects into separate individual tasks and identifying and defining any information related to each of the tasks identified or defined. Although the disclosure refers to tasks throughout, it will be readily apparent to those skilled in the art that if the project is a product to be made in the manufacturing industry, the task could be the operation or activity necessary to complete the product or project, a sub-assembly or a batch of the product.

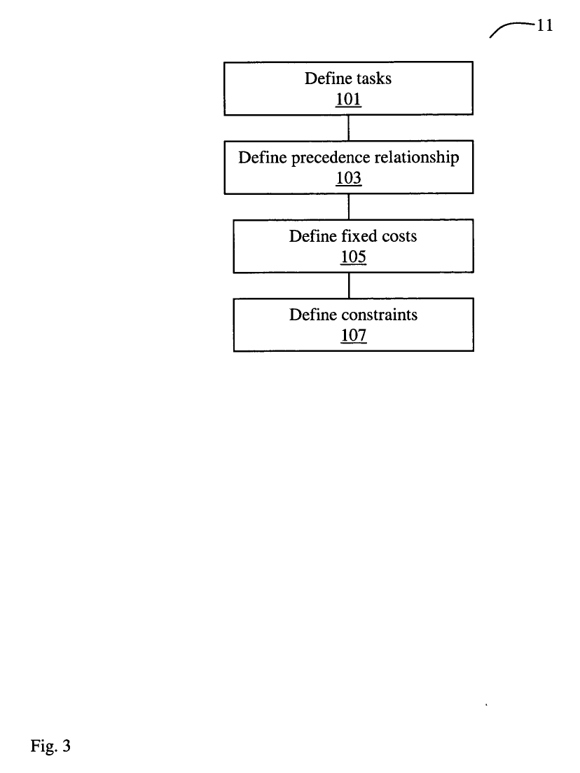

The steps comprising defining the project tasks and their resource requirements 11 are shown in FIG. 3 and comprise the following in no specific order: identifying and defining each individual task 101; identifying and defining any additional information related to each task such as any precedent relationships for each task 103; identifying and defining any fixed costs associated with each task 105 and identifying and defining any constraints 107.

Identifying and defining each individual task 101 involves breaking down the project or projects into manageable tasks, each of which can be executed from the beginning to end using the same type and level of resources.

Once all of the individual tasks are identified and defined 101, any additional information such as the precedence relationships between all of the individual tasks must be identified and defined 103. In some cases one task might require one or more other tasks to be completed before it can be started. This precedence relationship is identified and defined at this point. At this step 103, any specific order, in which the individual tasks must be completed, will be identified and defined as a precedence relationship. Commonly, one of the following four types of relationships are defined: a task must be started before another task starts, a task must be started before another task finishes, a task must be finished before another task finishes, and a task must be finished before another task starts. In addition, any precedence relationship between a task and a milestone must be defined.

Any fixed costs associated with each of the identified tasks are identified and defined 105. Fixed costs are costs that will be associated with the task that are not based on the usage time of the resources. Fixed costs might include such things as material cost, permits and other fees, etc. Also, the fixed costs should be identified and defined in conjunction with any milestones, dates, etc. they are related to.

For each individual task identified and defined any further constraints in relation to that task are identified and defined 107. These constraints can be anything that restrict or affect a task and can include: any dates the task must be finished by (i.e. a milestone); any specific days the task must start on; any specific days the task must start after; tasks that need to be completed by some one who is not being scheduled within this project, calendar date when certain resource is available or when a certain task can be undertaken (i.e. when the snow melts), etc. For each of the individual tasks identified and defined, any additional constraints are identified and defined 107.

If the method is implemented using a typical computer system such as the computer system 1 illustrated in FIG. 1, the projects, the set of tasks, any addition information related to each task, any fixed costs related to each of the tasks and any additional constraints associated with the task would be defined by inputting this information into the processing unit 3 using the input device 5 and the processing unit 3 storing the information as data in the memory storage device 7.

Resources

Referring again to FIG. 2, once all the steps identifying the tasks 11 are complete, the resources available must be identified and defined 15.

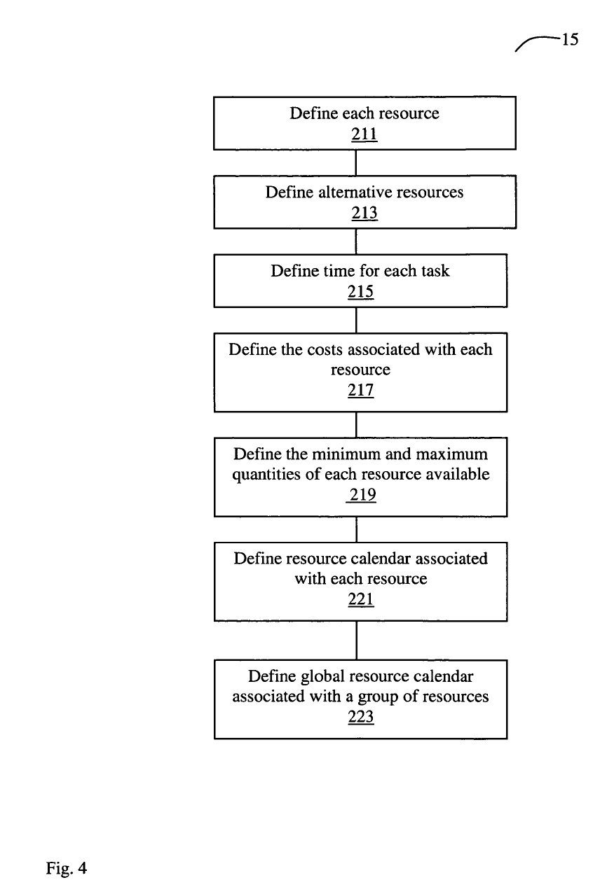

Referring to FIG. 4 illustrated are the steps involved in defining the resources 15. Defining the resources 15 comprise a number of steps in no specific order: defining the resources necessary for each task identified 211; optionally identifying and defining any alternative resources 213; specifying the time required to complete each task with each of the resources and combinations of resources and any alternative resources 215; identifying and defining the costs associated with each resource 217; specifying the minimum and maximum quantity of each resource available 219; creating the resource calendar 221; and creating a global calendar for a group of resources 223

For each task identified in step 11, the resources required to complete the task must be identified and defined 211. These resources can include: people, equipment available, services, office space or any other item that is required for scheduling. Additionally, the resources could be identified and defined 211 in the format of skills or operations to compete the task. This would allow a resource to be defined as having multiple skills or uses. For example the resource of a person could be defined as having multiple skills in plumbing or carpentry. This person would then be able to be used to complete either plumbing related tasks or carpentry related tasks.

Optionally, alternative resources for each task can be identified and defined 213. Often certain resources are identified that can be used to complete a task, however, in a number of cases alternative resources can be used to complete the same task. One example is mechanized versus manual labor. Another example is where either a large machine or a small machine can be used to complete a task. The large machine has a higher cost per day or hour then the small machine, but would require less time to complete the task. Another example is using more of each resource.

Next, the time necessary for each resource to complete a task is defined 215. Step 215 involves identifying the amount of time required to undertake that task using each resource or combination of different resources. Also, if any alternative resources are defined, specifying the time required to complete the task using the alternative resources or any combination of resources and alternate resources.

Next identify and define the costs associated with each resource 217. For each resource identified and defined, specify any other information about it: hiring cost, cost per hour, cost per day, cost per week, retrenchment cost, minimum time period of idleness before retrenchment, cost of moving a resource from one task to another or from one project to another, or any other related costs. Identify the costs related to the use of each of the resources: in the case of some resources, the cost of the resource will change depending upon the duration of its use, such as cost per hour, cost per day, cost per week and cost per month, etc. In the case of some resources, there may be a cost of hiring and retrenchment. In case of some resources, there may be a reduction in the cost if more than one resource is hired. Still in the case of other resources, the company may wish to have a minimum period in which the resource has to be idle before, the company will retrench the resource. In the case of some other resources there might be other types of costs. Finally, each resource would have a calendar which would specify the days and times when it would be available for use and the premium that has to be paid for overtime.

Next, identify and specify the quantities of each resource available 219. For each resource identified and defined, specify the minimum and maximum quantity of resources that are or could be available. For any alternative resource identified and defined, specify the minimum and maximum quantities available.

Next create the resource calendar 221 This step 221, involves creating a resource calendar for each resource identified and/or available; This is a calendar showing the working/non-working days and times of a resource, i.e. if employees only work 9 to 5 and don't work on weekends, statutory or other holidays. Also some resources will be available at different times on the calendars, such as workers on split shift, there might be a group of workers available for a first shift between 6 AM and 6 PM and a second shift of workers available between 6 PM and 6 AM to make workers available for a project around the clock. Additionally, the resources could be defined as having multiple skill sets or uses. For example, a resource could be defined as a person with skill sets for both plumbing and carpentry. This person would then be able to complete both plumbing and carpentry tasks.

Next create the global calendar 223. This step 223, involves creating a global calendar which would define the working/non-working days and times of a group of resources, and statutory and other holidays. The global calendar is the default calendar for all resources for which a resource calendar has not been specified.

If the method is implemented using a typical computer system such as the computer system 1 illustrated in FIG. 1, the resources necessary to complete each task, the time to complete the task using each resource, any costs associated with each resource and any additional information associated with the resource would be defined by inputting this information into the processing unit 3 using the input device 5 and the processing unit 3 could then store the information as data in the memory storage device 4.

Global Costs

Once the set of tasks are defined 11 and the resources are defined 15, the global costs 17 are identified and defined. Defining the global costs 17 involves identifying and defining all global costs associated with the project or projects. These costs can include: overhead cost per day, the interest cost per month, cost of finished goods inventory and cost of stock out.

If the method is implemented using a typical computer system such as the computer system 1 illustrated in FIG. 1, the global project costs would be defined by inputting this information into the processing unit 3 using the input device 5. The processing unit 3 can then store the information as data in the memory storage device 4.

Project Costs

Next, identify and define all the project costs 19. The project costs are costs or revenues (negative costs) that relate to each of the projects. These can include: the invoice amount for the completed project; if the project is a product to be manufactured the project costs can include the sale price of the completed product; opportunity cost related to earlier completion of each of the projects or work orders; the penalty cost related to the delayed completion of the project or work order; and, the over head costs related to each of the individual projects or work orders.

If the method is implemented using a typical computer system such as the computer system 1 illustrated in FIG. 1, the project costs would be defined by inputting this information into the processing unit 3 using the input device 5. The processing unit 3 can then store the information as data in the memory storage device 4.

Search Space

The search space identifies and defines where the optimal schedule may be in. Some of this search space is embedded in the definition of the tasks, the resources and the optimization operators. Specifically, the search space may be defined as a result of the definition of project tasks 11 and resources 15, including; the definition of alternative types of the resources that can be used to undertake each of the tasks; the definition of minimum and maximum number of each of the resources that could be available; and different sequence in which the various tasks could be undertaken in one project.

Risk Identification

The process can involve identifying and defining the risks related to the project 23 and using these defined risks to alter the schedule timing in accordance with any of the well known present practices such as the Monte Carlo method. Typically, these well known practices look at risks that are well known in the prior art and can include any number of risks. Typically the risks include: the risk associated with the variation in time taken to complete each task given the resources and quantity which could be the result of what process or method is used to undertake the task and the pace of the resource itself; the risk of mistakes being made causing delays in time to complete a task or increase the cost associated with a task; the risk of work delays and stoppages due to weather or other related events; the risk of unscheduled equipment failure; and the risk associated with variation in demand. Most of these risks can be quantified by the use of historical data and statistical forecasting techniques that are well known in the present art.

Uncertainity

It needs to be recognized that there is uncertainty in the inputs used in scheduling. For example, the cost of a task depends upon the time taken, which may historically vary and can only be estimated by a probability distribution. In that case, the cost of undertaking that task can only be computed via Monte Carlo estimation and would also be an estimated probability distribution. If one assumes that the distribution is Gaussian, the estimated distribution would be characterized by a mean and a standard deviation. Therefore, some objective and constraint measure would also be a probability distribution. If we assume Gaussian, then those distributions are also characterized by a mean and standard deviation. Business objectives on such a distribution could be for example: minimize total expected (mean) cost, minimize variance in total expected cost, maximize the probability that the variation will be less then a threshold etc.

One could alternatively, of course, just simplify and “pretend” that there is full certainty and treat the estimate of the mean as fully certain computed value (implying that the standard deviation is zero).

Defining Business Goals

Next, the business goals and operational goals of a schedule are defined 25. A business goal can be either a business objective or a business constraint and an operational goal can be either an operational objective or an operational constraint. An objective is a variable for the schedule for which the present invention will attempt to find an optimized schedule where this value of that variable is the “best” (minimum or maximum) for the optimized schedule in relation to all of the other schedules. A constraint is a variable for the schedule for which an upper value, lower value or exact value of the variable in the schedule that a schedule must meet in order for it to be considered a feasible schedule.

In one example, the schedule can be constructed to optimize a business goal where the goal is at least one business objective. This business objective will be the metric by which the schedule is optimized. This business objective can be anything that it is desirable to maximize or minimize in a schedule and can be given a measurable value. Business objectives can include: a minimization of total cost; a maximization of total sales value of the production; a maximization of total profit; maximization of customer satisfaction or other business objectives.

Alternatively, the business goal can consist of at least one business constraint. The business constraint can be an upper value, lower value or equal value. The constraint could be a business constraint such as an upper constraint on the total cost of a schedule or the lower limit for the profit in conducting a set of projects. Business constraints can include: the total cost of the schedule; the total sales value of the production; the total profit; a metric related to customer satisfaction or other business constraints.

The present invention can also allow multiple goals to be defined at this step 25. The present invention can allow any mix of at least one business goal and zero or more operational goals. For example, a first business objective and a second objective can be defined and the present invention can optimize the schedules for the first business objective and the second objective. The first business objective is a business objective, but the second objective could be either a business objective or an operational objective. Also, it is contemplated that while the disclosure talks about a first business objective and a second objective any number of objectives could be defined and the present method could optimize the schedule for any practical amount of objectives. Alternatively, a business constraint and a business objective could be defined as a business goal or a business constraint and an operational objective could be defined as a business goal. The present invention contemplates the definition of multiple goals where there is at least one business goal to be defined and zero or more operational goals to be defined at this step 25.

Additionally, if a first business objective and second objective are defined and/or any additional number of objectives, the user can assign a weight to each of the first business objective, the second objective and any additional objectives, which can bias the searching towards the more heavily weighted objectives.

If multiple goals can be defined in the present invention including allowing more than one constraint, then provisions can be made to manage nondominated tradeoffs that include tradeoffs among constraints. This is important for the case where the optimizer is not able to generate feasible schedules, and therefore the user needs to choose from among the infeasible schedules. That is, the user chooses which schedules is the “least unacceptable”.

If the method is implemented using a typical computer system such as the computer system 1 illustrated in FIG. 1, the business objective will be defined by inputting this information into the processing unit 3 using the input device 5. The processing unit 3 can then save the information as data in the memory storage device 4.

Construction/Determination of the Optimum Schedule

“Optimization” is used in the present sense as referring to a process of traversing a space of possible schedules using the search strategy and the optimization operators. When a schedule has been “optimized” in accordance with the present invention, it means that several candidate schedules have been evaluated and the best schedule or schedules have been identified, according to the specified goals, constraints, search space, and stopping conditions. Stopping conditions may be, for example: maximum runtime, maximum number of iterations for the given search strategy and the optimization operators, or a solution that satisfies all constraints has been found and there are no objectives. The solution or solutions may not be the best possible schedule or schedules in the whole search space due to the finite running time of the system, but they are the best found before the stopping conditions are met.

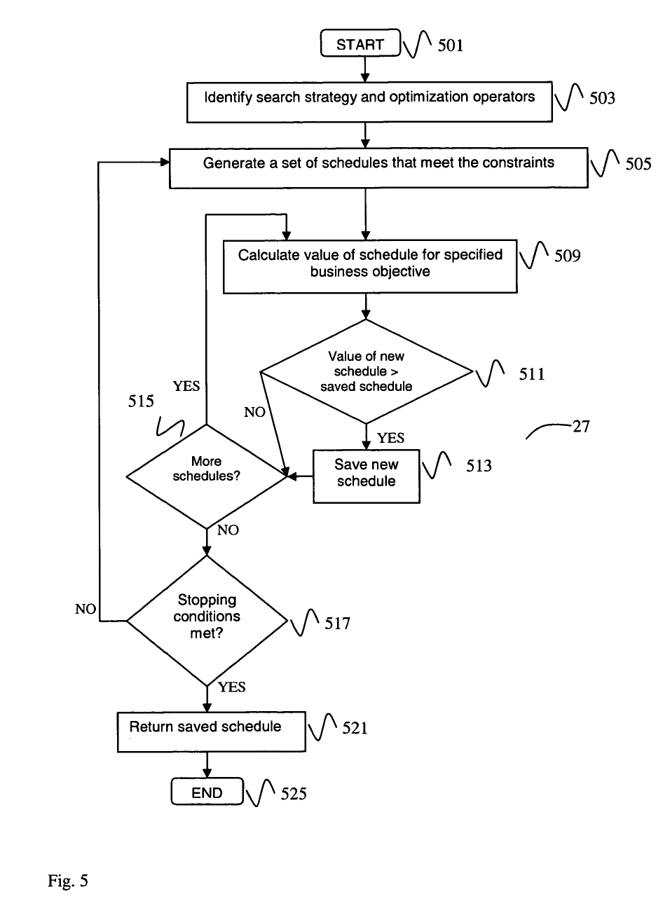

FIG. 5 illustrates one method of performing this optimization step where the business goal is defined as one business objective and no operational objectives are defined. In this embodiment, the optimization step 27 comprises the following operations: starting the process 501; inputting the search strategy and the optimization operators 503; generating a set of schedules to be evaluated 505; calculating the value of a schedule for the defined business objective 509; checking whether the value of the schedule is better than the value of the saved schedule 511; saving a schedule 513; checking if the stopping conditions are met 515; checking if any iterations remain 517; returning the saved schedule 521; and ending the process 525.

After the method 27 is started 501, the search strategy and the optimization operators are input 503. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection etc.

Next, a set of schedules containing one or more schedules must be generated 505. These schedules must be generated in such a manner that the constraints imposed on the tasks and the resources are taken into account and the schedule generated is a feasible schedule. For each generated schedule, a scheduler will build the schedule and the schedule will be checked to see if the schedule is “feasible”. A “feasible” schedule is one that meets all the constraints defined for the project tasks and resources.

Because of advances in computer technology, typical computer systems now have the capacity to generate a large population of feasible schedules in relatively little time. Using a typical computer system such as computer system 1, shown in FIG. 1, a population of feasible schedules can be generated by the processing unit 3 and stored in the memory storage device 4 in an acceptable length of time. This feat is unable to be duplicated in a realistic amount of time manually.

Referring again to FIG. 5, the value of the business objective that has been defined will be calculated in order to be optimized 509 for the first schedule. The value of the business objective for the schedule is calculated. For example, when the identified business objective is a minimization of cost, the total cost of each schedule will be calculated. For the example of generating an optimized schedule for minimized total cost, the values for the total cost of the schedules can be calculated for each schedule generated by adding up all the defined costs, such as the fixed costs, project costs, resource time based costs and other costs and simply evaluating the schedule on its total cost. For the example of generating an optimized schedule for total sales value of the production, the sales value of each of the projects undertaken over the duration of the schedule can be added up. For the example of total profit, the schedule that is optimized for the business objective of maximum total profit could be the one that results in the lowest total cost of all of the projects the schedule is to undertake, subtracted from the sales price of each of the projects. For the example of total customer satisfaction, the schedule that is optimized for the business objective of maximum total customer satisfaction would be the schedule that maximizes the total customer satisfaction over a given period of time. Total customer satisfaction can be maximized by calculating a metric based on the due date and the scheduled completion date for each of the projects and the value the company gives to achieving or beating these due dates.

For the first schedule in a set of schedules, the first schedule will be saved 513. If a typical computer system 1 is used to implement the present method the processing unit 3 would save this schedule in the memory storage device 4.

The process 27 will then determine if there is another schedule in the set 515. If there is a next schedule, steps 509, 511 and 513 will be repeated. The value of the defined business objective for the schedule is calculated 509. This value is then compared to the value of the saved schedule. While the term greater is used to evaluate which is the better schedule based on the business objective, it will be understood that for some business objectives such as time and cost, a lower value is desirable. If the value of the new schedule is better than the saved schedule, the new schedule will be saved 513 and then the process will check if there are any more schedules 515. If the value of the new schedule is not better than the saved schedule, the new schedule will not be saved and the process will check if there are any more schedules 515.

Once there are no more schedules in a set, the process will check if the stopping conditions have been met 517. If the stopping conditions have not been met, the program will generate another set of schedules that meet the constraints 505 and repeat steps 509, 513, and 507. If the stopping conditions have been met, return the saved schedule 521 and end 525 the process 27. If a typical computer system such as the typical computer system 1 of FIG. 1 is used to implement the method the display means 7 can be operative to display the schedule to the user.

When the program iterates a new solution and generates a new set of schedules 505, the program will vary the new generation of schedules based on the search strategy and the optimization operators that were identified and defined. This search strategy can involve any process as is commonly known in the art such as using genetic algorithm, hill climber or other known processes. The optimization operators can involve the operators described earlier.

if the present invention is implemented using a typical computer system such as the computer system 1 illustrated in FIG. 1, the processing unit 3 is operative for: starting the process 501; receiving the search strategy and the optimization operators 503 from the input device 5; generating a set of schedules 505; calculating the “value” of a schedule for a defined business objective 509; checking whether the “value” of the schedule is better than the “value” of the saved schedule 511; saving a schedule 513; checking if any schedules remain in a set 515; checking if the stopping conditions have been met 517; returning the saved schedule 521; and ending the process 525. The display device 7 is operative in the computer system 1 to display data and may be used to display to a user the returned schedule.

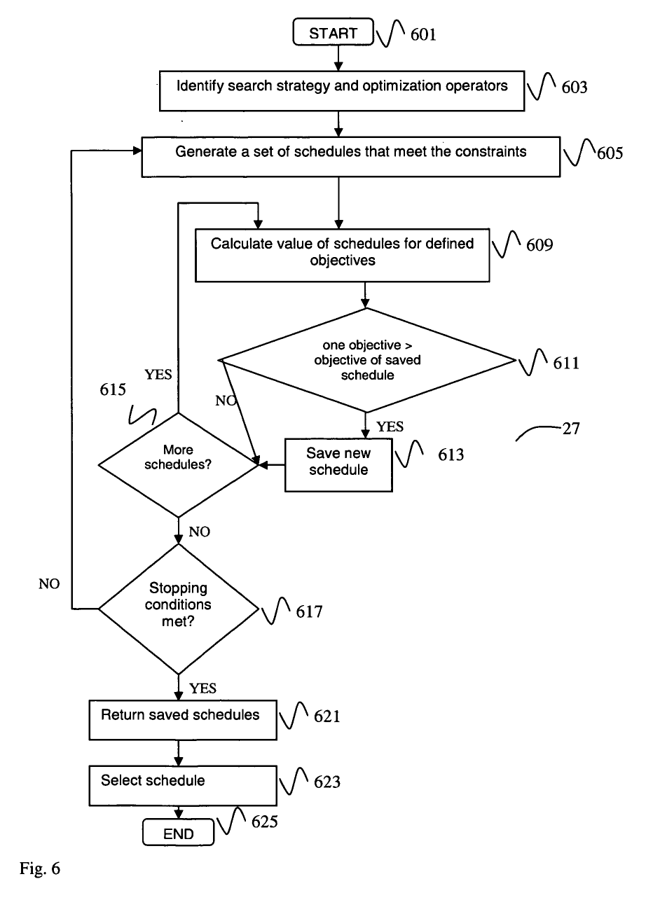

An alternative embodiment of process 27 using a defined first business goal and a second goal is illustrated in FIG. 6. In this embodiment the first business goal is a business objective and the second goal can be either a business objective or an operational objective. In this embodiment, the optimization step 27 comprises the following operations: starting the process 601; inputting the search strategy and optimization operators 603; generating a set of schedules 605; calculating the values of a schedule for the first business objective and the second objective 609; checking whether one of the values of either the first business objective or the second objective of the schedule is better than the value of a saved schedule 611; saving a schedule 613; checking if any schedules remain in a set 615; checking if the stopping conditions have been met 617; returning the saved schedules 621; allowing a user to select one of the outputted schedules 623 and end the process 625.

After the method 27 is started 601, the search strategy and the optimization operators are input 603. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection, etc.

Next, a set of schedules must be generated 605. One or more schedules must be generated. As in the previous embodiment of optimization process 27, these schedules must be generated in such a manner that the constraints imposed on the tasks and the resources are taken into account and the schedule generated is a feasible schedule. For each generated schedule, a scheduler will construct the schedule and the program will check to see if the schedule is feasible.

Next, the program 27 will calculate the values of the first business objectives and the second objective defined in order to be optimized 609 for the first schedule. The value of each of the first business objective and the second objective for the schedule is calculated. For example, when the first business objective is a minimization of cost and the second objective is the maximization of resource usage, the total cost of the schedule and the utilization of the resources in the schedule will be calculated.

As outlined above, the first business objective is a business objective and the second objective could be either a business objective or an operational objective. Additionally, it will be understood that the present invention could optimize for any practical number of additional objectives whether they are business objectives or operational objectives by defining them and the process would then evaluate each schedule in the same manner as disclosed herein by evaluating each additional defined objective.

For the first schedule in a set of schedules, the first schedule will be saved 613.

The process 27 will then determine if there is another schedule in the set 615. If there is a next schedule, steps 609, 611 and 613 will be repeated. The first business objective and the second objective of the next schedule will then be determined 609. These new values will then be compared against the first business objective and the second objective of the saved schedules 711. If either the first business objective or the second objective of the new schedule is better than any of the saved schedules the new schedule will be saved. If both the first business objective and the second objective of the new schedule are better than the first business objective and the second objective of the saved schedule, the new schedule will be saved in its place 613. This process creates a group of saved schedules, where each schedule has a better value than the rest of the saved schedules in at least one of the defined objectives or constraints.

Additionally, further provisions could be made in the program to further generate a set of saved nondominated schedules. (A nondominated schedule is one in which no other schedule is better in all ways).

The process will then check if there are any more schedules 615. If the business objectives of the new schedule are not better than any of the business objectives of the saved schedules the new schedule will not be saved and the process will check if there are any more schedules 615.

Once there are no more schedules in a set 615, the program will check if the stopping conditions have been met 617. If the stopping conditions have not been met, the program will generate another set of schedules that meet the constraints 605 and repeat steps 609, 613, and 607. Again, this iterative step will be undertaken using the specified search strategy and the optimization operators defined in 603.

If the stopping conditions have been met, the saved schedules will be returned 621. The saved schedules will then be displayed and the user will then be able to select the schedule they desire 623. The set of nondominated schedules can provide the user with the choice of all the saved nondominated schedules, allowing the user to make informed choices in the ultimate schedule by judging the tradeoffs involved among the different objectives. Additionally, priorities and preferences for the objectives may be taken into account, for example by user-defined weights for each objective which biases the searching towards the more heavily weighted objectives.

Once the desired schedule is selected 623 the process 27 will end 625.

If the present invention is implemented using a typical computer system such as the computer system 1 illustrated in FIG. 1, the processing unit 3 is operative for: starting the process 601; receiving the search strategy and the optimization operators 603 from the input device 5; generating a set of schedules 605; calculating the “value” of a schedule for a defined business objective 609; checking whether the “value” of the schedule is better than the “value” of the saved schedule 611; saving a schedule 613; checking if any schedules remain in a set 615; checking if the stopping conditions have been met 617; returning the saved schedules 621; allowing a user to select a schedule from the saved schedules 623and ending the process 625. The display device 7 is operative in the computer system 1 to display data and may be used to display to a user the returned schedule.

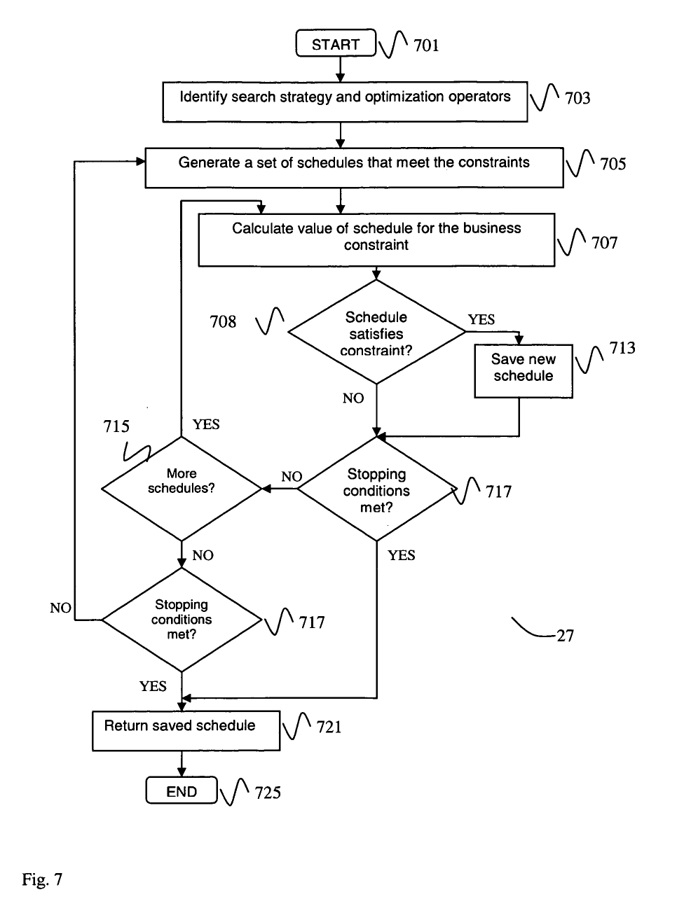

FIG. 7 illustrates one method of performing this optimization step for a business goal that consists of a business constraint. In this embodiment, the optimization step 27 comprises the following operations: starting the process 701; inputting the search strategy and the optimization operators 703; generating a set of schedules to be evaluated 705; calculating the value of a schedule for the defined business constraint 707; checking whether the value of the schedule for the defined business constraint is satisfied 708; saving a schedule 713; checking if any schedules remain in a set 715; checking if the stopping conditions have been met 717; returning the saved schedule 721; and ending the process 725.

After the method 27 is started 701, the search strategy and the optimization operators are inputted 703. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection, etc.

Next, a set of schedules containing one or more schedules must be generated 705. These schedules must be generated in such a manner that the constraints imposed on the tasks and the resources are taken into account and the schedule generated is a feasible schedule. For each generated schedule, a scheduler will build the schedule and the schedule will be checked to see if the schedule is feasible based on the constraints defined in association with the tasks and resources.

The value of the defined business constraint for the schedule will then be calculated 707. Next, the value of the business constraint will be checked to see if it is satisfies the business constraint as defined 708. For the example of a business constraint being a maximum value for total cost of the schedule, this step would determine the value of the cost of the schedule based on the defined associated costs of the schedule and determine whether the total cost of the schedule is equal or below the maximum cost defined for the business constraint. If the total cost of the schedule is equal or less than the defined total cost of the business constraint, the schedule will have satisfied the business constraint and will be added to the set. Again, the business constraint can be defined as a higher limit, lower limit or equal limit.

If the schedule satisfies the defined business constraint, the schedule will be saved 713. If a typical computer system 1 is used to implement the present method the processing unit 3 would save this schedule in the memory storage device 4.

The process 27 will then determine if the stopping conditions have been met 717. This is especially important when only one business constraint has been defined. If the stopping conditions have not been met, the process will check whether there is another schedule in the set 715. If there is a next schedule, steps 707, 708, 713 and 717 will be repeated. Once there are no more schedules in a set, the process will check if the stopping conditions have been met 717. If the stopping conditions have not been met, the program will generate another set of schedules 705 and repeat steps 707, 708, 713 and 717. If the stopping conditions have been met 717, the saved schedule will be returned 721 and end 725 the process 27. If a typical computer system such as the typical computer system 1 of FIG. 1 is used to implement the method the display means 7 can be operative to display the schedule to the user.

If the present invention is implemented using a typical computer system such as the computer system 1 illustrated in FIG. 1, the processing unit 3 is operative for: starting the process 701; receiving the search strategy and the optimization operators 703 from the input device 5; generating a set of schedules 705; calculating the value of a defined business constraint 707; determining if the value of the defined business constraint satisfies the defined business constraint 708; saving a schedule 713; checking if any schedules remain in a set 715; checking if the stopping conditions have been met 717; returning the saved schedule 721; and ending the process 725. The display device 7 is operative in the computer system 1 to display data and may be used to display to a user the returned schedule.

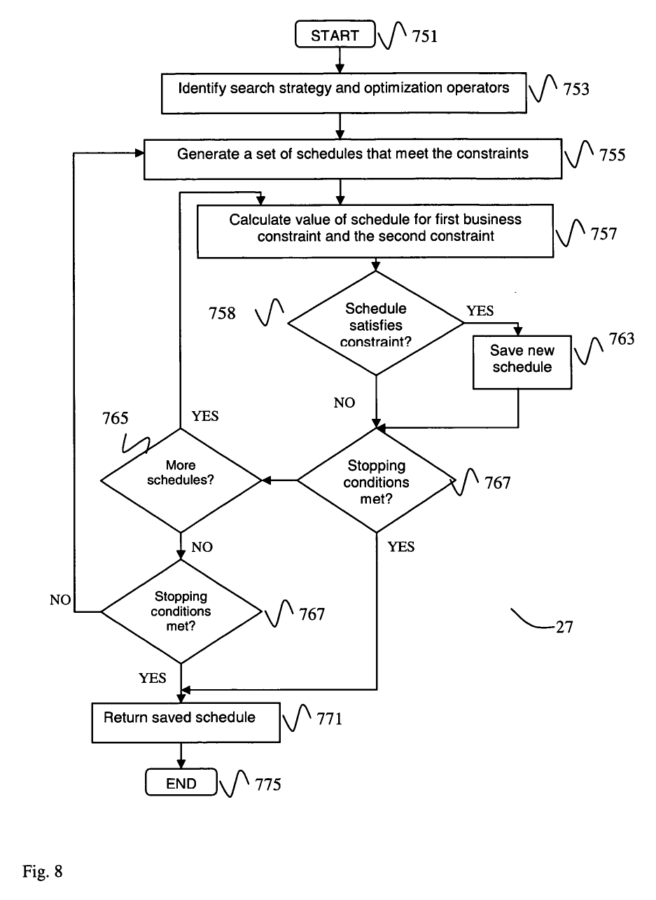

FIG. 8 illustrates a method of performing this optimization step for a business goal that consists of first business constraint and a second constraint, where the second constraint can be either a business constraint or an operational constraint. In this embodiment, the optimization step 27 comprises the following operations: starting the process 751; inputting the search strategy and optimization operators 753; generating a set of schedules to be evaluated 755; calculating the value of a schedule for the first business constraint and the second constraint 757; checking whether the values of the schedule for the defined first business constraint and the second constraint satisfies the defined first business constraint and the second constraint 758; saving a schedule 763; checking if any schedules remain in a set 765; checking if the stopping conditions have been met 767; returning the saved schedule 771; and ending the process 775.

After the method 27 is started 751, the search strategy and optimization operators are inputted 753. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection, etc.

Next, a set of schedules containing one or more schedules must be generated 755. These schedules must be generated in such a manner that the constraints imposed on the tasks and the resources are taken into account and the schedule generated is a feasible schedule. For each generated schedule, a scheduler will build the schedule and the schedule will be checked to see if the schedule is feasible based on the constraints defined in association with the tasks and resources.

The value of the first business constraint and the second constraint for the schedule will then be calculated 757. The first business constraint can be any business constraint the user wishes to define and the second constraint can be either a business constraint or an operational constraint.

Next, the value of the first business constraint and the second constraint will be checked to see if the schedules satisfy the defined first business constraint and the second constraint 858. If the schedule satisfies the first business constraint and the second constraint, the schedule will be saved 763. If a typical computer system 1 is used to implement the present method the processing unit 3 would save this schedule in the memory storage device 4.

The process 27 will then determine if the stopping conditions have been met 767. If the stopping conditions have not been met, the process will check whether there is another schedule in the set 765. If there is a next schedule, steps 757, 758, 763 and 767 will be repeated.

Once there are no more schedules in a set, the process will check if the stopping conditions have been met 767. If the stopping conditions have not been met, the program will generate another set of schedules 755 and repeat steps 757, 758, 763 and 767. If the stopping conditions have been met 767, the saved schedule will be returned 771 and end 775 the process 27. If a typical computer system such as the typical computer system 1 of FIG. 1 is used to implement the method the display means 7 can be operative to display the schedule to the user.

If the present invention is implemented using a typical computer system such as the computer system 1 illustrated in FIG. 1, the processing unit 3 is operative for: starting the process 751; receiving the search strategy and the optimization operators 753 from the input device 5; generating a set of schedules 755; calculating the value of a defined business constraint 757; determining if the value of the defined business constraint is satisfied based on the defined business constraint 758; saving a schedule 763; checking if any schedules remain in a set 765; checking if the stopping conditions have been met 767; returning the saved schedule 771; and ending the process 775. The display device 7 is operative in the computer system 1 to display data and may be used to display to a user the returned schedule.

As outlined above, the first business constraint is a business constraint and the second constraint could be either a business constraint or an operational constraint. Additionally, it will be understood that the present invention could optimize for any practical number of additional constraints whether they are business constraints or operational constraints by defining them and the process would then evaluate each schedule in the same manner as disclosed herein by evaluating each additional defined constraint and determine if the schedule is feasible for each additional constraint.

Additionally, further provisions could be made in the program to further generate a set of saved nondominated schedules. (A nondominated schedule is one in which no other schedule is better in all ways).

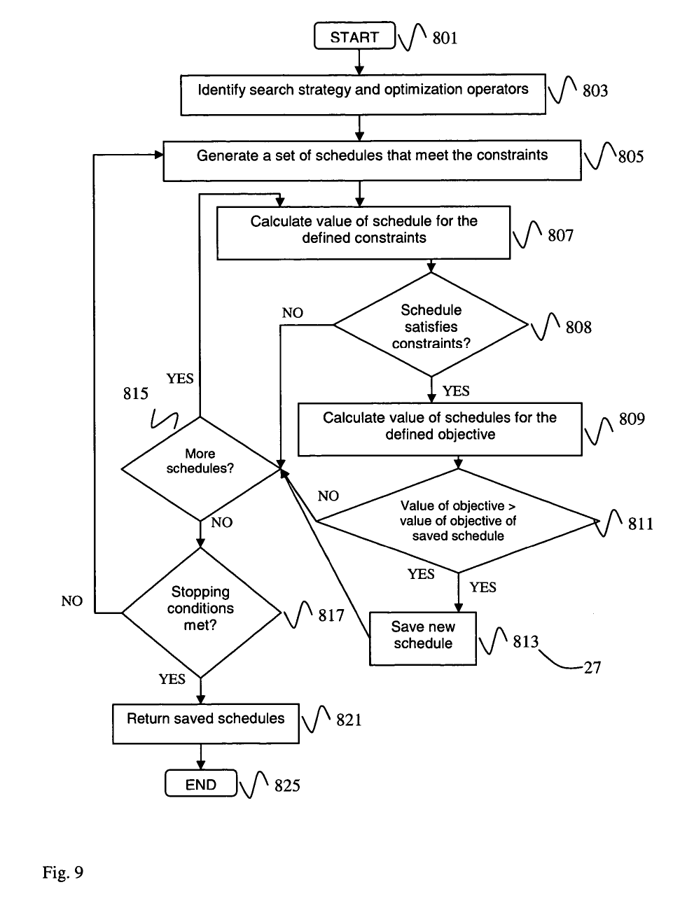

FIG. 9 illustrates one method of performing this optimization step where the business goal is defined and there is at least one constraint, either a business constraint or an operational constraint and there is an objective, either a business objective or an operational objective, defined. In this embodiment, the optimization step 27 comprises the following operations: starting the process 801; inputting the search strategy and the optimization operators 803; generating a set of schedules to be evaluated 805; calculating the value of a schedule for the at least one constraint 807; checking if schedule satisfies the at least one defined constraint 808; calculating the value of a schedule for the defined objective 809; checking whether the value of the schedule is better than the value of the saved schedule 511; saving a schedule 513; checking if the stopping conditions are met 515; checking if any iterations remain 517; returning the saved schedule 521; and ending the process 525.

After the method 27 is started 801, the search strategy and the optimization operators are input 803. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection, etc.

Next, a set of schedules containing one or more schedules must be generated 805. These schedules must be generated in such a manner that the constraints imposed on the tasks and the resources are taken into account and the schedule generated is a feasible schedule.

Next, the values of the at least one defined constraints will be determined 807 and these values will be checked to see if the schedule satisfies at least one defined business constraint 808. If the schedule does not satisfy the at least one constraint, the process will determine if there are any more schedule in the set to check 815. If the schedules satisfies the at least one constraint at this step 808, the value of the defined objective is calculated 809 for the first schedule. The value of the objective for the schedule is calculated. If at least one of the defined constraints is a business constraint, this objective can be either a business objective or an operational objective.

For the first schedule in a set of schedules, the first schedule will be saved 813. If a typical computer system 1 is used to implement the present method the processing unit 3 would save this schedule in the memory storage device 4.

The process 27 will then determine if there is another schedule in the set 815. If there is a next schedule, steps 807, 808, 809, 811 and 813 will be repeated. The value of the defined constraints will be calculated 807 and these values checked to determine if the schedule satisfies the constraints 808. If the schedule does not satisfy the constraints, the method will move to step 813 and check for any more schedules in the set. If the schedule satisfies the defined constraints, the value of the defined objective for the schedule is calculated 809. This value is then compared to the value of the saved schedule. While the term greater is used to evaluate which is the better schedule based on the business objective, it will be understood that for some business objectives such as time and cost, a lower value is desirable. If the value of the new schedule is better than the saved schedule, the new schedule will be saved 813 and then the process will check if there are any more schedules 815. If the value of the new schedule is not better than the saved schedule, the new schedule will not be saved and the process will check if there are any more schedules 815.

Once there are no more schedules in a set, the process will check if the stopping conditions have been met 817. If the stopping conditions have not been met, the program will generate another set of schedules 805 and repeat steps 807, 808, 809, 811 and 813. If the stopping conditions have been met, return the saved schedule 821 and end 825 the process 27. If a typical computer system such as the typical computer system 1 of FIG. 1 is used to implement the method the display means 7 can be operative to display the schedule to the user.

When the program iterates a new solution and generates a new set of schedules 805, the program will vary the new generation of schedules based on the optimization operators that were identified and defined. This iteration process can involve any process as is commonly known in the art such as using genetic algorithm, hill climber or other known processes.

If the present invention is implemented using a typical computer system such as the computer system 1 illustrated in FIG. 1, the processing unit 3 is operative for: starting the process 801; receiving the search strategy and the optimization operators 803 from the input device 5; generating a set of schedules 805; calculating the “value” of a defined objective 807; determining if the schedule is feasible based on the defined constraints 808; calculating the value of a schedule for a defined business objective 809; checking whether the value of the schedule is better than the value of the saved schedule 811; saving a schedule 813; checking if any schedules remain in a set 815; checking if the stopping conditions have been met 817; returning the saved schedule 821; and ending the process 825. The display device 7 is operative in the computer system 1 to display data and may be used to display to a user the returned schedule.

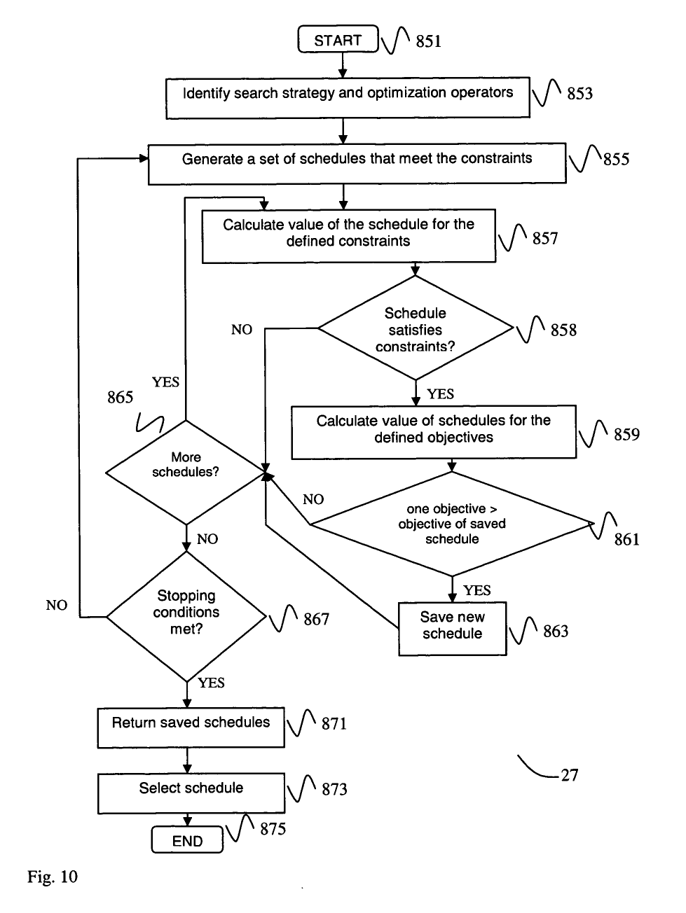

FIG. 10 illustrates one embodiment of process 27 where the business goal is defined and at least one constraint and a first objective and a second objective. If at least one of the constraints is a business constraint, both objectives could be either business objectives or operational objectives. If none of the constraints are business constraints one of the objectives must be a business objective.

In this embodiment, the optimization step 27 comprises the following operations: starting the process 851; inputting the search strategy and the optimization operators 853; generating a set of schedules 855; calculating the value of the at least one business constraint 857; determining if the schedule satisfies the at least on business constraint 858; calculating the calculating the values of a schedule for the first objective and the second objective 859; checking whether one of the values of either the first objective or the second objective of the schedule is better than the value of a saved schedule 861; saving a schedule 863; checking if any schedules remain in a set 865; checking if the stopping conditions have been met 867; returning the saved schedules 871; allowing a user to select one of the output schedules 873 and ending the process 875.

After the method 27 is started 851, the search strategy and optimization operators are input 853. The optimization operators receive instructions from the search strategy and move the search to a new node in the defined search space for each schedule during the optimization process 27 and can include: alternative resource selection; alternative required resource capacity selection; resource capacity selection between specified minimum and maximum capacities for each resources; project scheduling sequence selection; task scheduling sequence selection; and operation start time selection, etc.

Next, a set of schedules must be generated 855. One or more schedules must be generated. These schedules must be generated in such a manner that the constraints imposed on the tasks and the resources are taken into account and the schedule generated is a feasible schedule.

Next, the value of the at least one constraint will be determined 857 and checked to see if the schedule satisfies the at least one business constraint 858. If the schedule does not satisfy the at least one business constraint, the program will check to see if there are any more schedules in the set 865. If the schedule is feasible 858, the values of the first objectives and the second objective for the schedule will be calculated 859. If at least one of the constraints is a business constraint, both objectives could be either business objectives or operational objectives. If none of the constraints are business constraints the first objective must be a business objective. For example, when the first objective is a business objective of total profit and the second objective is the maximization of resource usage, the total profit of the schedule and the utilization of the resources in the schedule will be calculated.

As outlined above, the first objective and the second objective can be either business objectives or operational objectives, if a business constraint is defined. Additionally, it will be understood that the present invention could optimize for any practical number of additional objectives whether they are business objectives or operational objectives by defining them and the process would then evaluate each schedule in the same manner as disclosed herein by evaluating each additional defined objective.

For the first schedule in a set of schedules, the first schedule will be saved 863.

The process 27 will then determine if there is another schedule in the set 865. If there is a next schedule, steps 857, 858, 859, 861 and 863 will be repeated. The value of the at least one business constraint 857 will be calculated and these values will be used to determine whether the schedule satisfies the at least one business constraint 858. The first objective and the second objective of the next schedule will then be determined 859. These new values will then be compared against the first objective and the second objective of the saved schedules 861. If either the first objective or the second objective of the new schedule is better than any of the saved schedules the new schedule will be saved. If both the first objective and the second objective of the new schedule are better than the first objective and the second objective of the saved schedule, the new schedule will be saved in its place 863. This process creates a group of saved schedules, where each schedule has a better value than the rest of the saved schedules in at least one of the defined objectives.

Additionally, further provisions could be made in the program to further generate a set of saved nondominated schedules. (A nondominated schedule is one in which no other schedule is better in all ways).

The process will then check if there are any more schedules 865. If either the first objective or the second objective of the new schedule is not better than either the first objective of the second objective of the saved schedules the new schedule will not be saved and the process will check if there are any more schedules 865.

Once there are no more schedules in a set 865, the program will check if the stopping conditions have been met 867. If the stopping conditions have not been met, the program will generate another set of schedules that meet the constraints and the at least one business constraint 855 and repeat steps 857, 858, 859, 861 and 863. Again, this iterative step can be done in any of the present known manner including using genetic algorithms, hill climber or other well known methods.

If the stopping conditions have been met, the saved schedules will be returned 871. The saved schedules will then be displayed and the user will then be able to select the schedule they desire 873. The set of nondominated schedules can provide the user with the choice of all the saved nondominated schedules, allowing the user to make informed choices in the ultimate schedule by judging the tradeoffs involved among the different objectives. Additionally, priorities and preferences for the objectives may be taken into account, for example by user-defined weights for each objective which biases the searching towards the more heavily weighted objectives.

Once the desired schedule is selected 873 the process 27 will end 875.

If the present invention is implemented using a typical computer system such as the computer system 1 illustrated in FIG. 1, the processing unit 3 is operative for: starting the process 851; receiving the search strategy and the optimization operators 853 from the input device 5; generating a set of schedules 855; calculating the value of a schedule for at least one constraint 857; checking whether the schedule satisfies the at least one constraint 858; calculating the value of a schedule for a defined business objective 859; checking whether the value of the schedule is better than the value of the saved schedule 861; saving a schedule 863; checking if any schedules remain in a set 865; checking if the stopped conditions have been met 867; returning the saved schedules 871; allowing a user to select a schedule from the saved schedules 873 and ending the process 875. The display device 7 is operative in the computer system 1 to display data and may be used to display to a user the returned schedule.

Track Execution

Referring again to FIG. 2, for better more accurate results, the execution of the project according to the schedule can be tracked 29. The progress of the completion of each task and actual resource usage will be tracked, keeping actual numbers for how the project progresses.

Updating of Schedule

In conjunction with tracking the execution of the project or projects 29, the schedule can be updated 31. The schedule is updated 31 by replacing the estimates and number identified in steps 11, 15, 17, 19 and 23 initially with the actual numbers that are measured during the completion of each of the completed tasks and identifying the percentage of which each task which is currently under way is completed. Any of steps 11, 15, 17, 19, 21, 23 or 25 can then be updated and their defined information re-defined. Process 27 can then be repeated using the updated information to result in a new updated and optimized schedule based on the actual numbers and measurements that are identified.

If the method is to be implemented using a typical computer system such as the computer system 1 illustrated in FIG. 1, the redefined information will be inputting into the processing unit 3 using the input device 5. The processing unit 3 can then save the information as data in the memory storage device 4. The processing unit 3 can then construct a new optimal schedule 27.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of building an optimized schedule to complete at least one project, the schedule being optimized for at least one business goal, said method comprising:
parsing said at least one project into a plurality of tasks;
in respect of each task;
defining fixed costs associated with the task;
defining task constraints associated with the task;
defining at least one resource capable of completing the task and in respect of the resource:
defining the time to complete the task using the at least one resource;
defining costs associated with the at least one resource;
and defining resource constraints associated with the at least one resource;
defining at least one business goal;
generating a set of alternate schedules containing at least one alternate schedule, each alternate schedule being feasible based on any task constraints and any resource constraints and determining an optimization score for each alternative schedule based on the at least one business goal; and
determining the alternate schedule with the best optimization score, being the optimized schedule; and
returning the optimized schedule.

2. The method of claim 1 wherein the at least one business goal comprises a business objective and the business objective comprises a defined variable to be maximized in the optimized schedule.

3. The method of claim 1 wherein the at least one business goal comprises a business objective and the business objective comprises a defined variable to be minimized in the optimized schedule.

4. The method of claim 1 wherein the at least one business goal comprises a business constraint and the business constraint comprises a defined value and wherein a defined variable in the optimized schedule must have a value lower than the defined value.

5. The method of claim 1 wherein the at least one business goal comprises a business constraint and the business constraint comprises a defined value and wherein a defined variable in the optimized schedule must have a value higher than the defined value.

6. The method of claim 1 wherein the at least one business goal comprises a business constraint and the business constraint comprises a defined value and wherein a defined variable in the optimized schedule must have the same value as the defined value.

7. The method of claim 1 comprising defining any global costs associated with the at least one project

8. The method of claim 1 comprising defining any project costs associated with the at least one project.

9. The method of claim 1 comprising allowing a user to choose from a range of alternate schedules with different optimization scores and returning an optimized schedule based on the user's selection.

10. The method of claim 6 wherein the number of schedules is a nondominated set of schedules.

11. The method of claim 1 further comprising defining operation operators and use of the optimization operators in the generation of said set of alternate schedules to alter said alternate schedules.

12. The method of claim 1 comprising defining at least one alternative resource that can be used to complete at least one of the tasks and defining the time required to complete the task using the at least one alternative resource, the costs associated with the at least one alternative resource and the resource constraints associated with the at least one alternative resource.

13. The method of claim 1 wherein in respect of a resource, defining for each resource the minimum and maximum number of that resource available and defining the time required to complete the task for each number of resources between the minimum and maximum number.

14. The method of claim 1 wherein the task constraints for a task comprises a precedence relationships between the task and another task.

15. The method of claim 1 further comprising:
partially executing the at least one project in accordance with the optimized schedule;
for each task that has been completed, redefining the fixed costs the task constraints and for each resource defined for the task redefining the time to complete the task using the at least one resource, costs associated with at least one resource and the resource constraints, using actual numbers based on the real results incurred completing the task;
for each task that has been partially completed, redefining the fixed costs and the task constraints and for each resource defined for the task redefining the time to complete the task using the at least one resource, costs associated with at least one resource and the resource constraints using actual numbers based upon the real results incurred in partially completing the task and multiplying the number by the percentage the task is completed.
using the redefined values, regenerating a set of alternate schedules containing at least one alternate schedule, each alternate schedule being feasible based on any revised task constraints and any revised resource constraints and determining an optimization score for each alternative schedule based on the at least one business goal; and
determining the alternate schedule with the best optimization score, being the optimized schedule; and
returning the optimized schedule

16. The method of claim 1 comprising, until a set of stopping conditions are met: generating an additional set of alternative schedules to complete said at least one project, the set of alternative schedules containing at least one alternative schedule, the additional set of schedules being feasible, based on the task constraints and resource constraints and determining an optimization score for each said alternate schedule; determining the alternate schedule with the best optimization score, being the optimized schedule; and returning the optimized schedule.

17. The method of claim 1 comprising defining the risks related to the at least one project and factoring the risks into generating the set of schedules.

18. The method of claim 1 comprising defining a first business goal and a second goal and the optimization score for each alternative schedule is based on the first business goal and the second goal.

19. The method of claim 15 wherein the first business goal comprises a business objective.

20. The method of claim 15 wherein the first business goal comprises a business constraint.

21. The method of claim 15 wherein the second goal comprises a business goal.

22. The method of claim 15 wherein the second goal comprises a business objective.

23. The method of claim 15 wherein the second goal comprises a business constraint.

24. The method of claim 15 wherein the second goal comprises an operational goal.

25. The method of claim 15 wherein the second goal comprises an operational objective.

26. The method of claim 15 wherein the second goal comprises an operational constraint.

27. The method of claim 1 wherein there is a first project and a second project and the set of tasks need to complete both the first project and the second project make up the set of tasks.

28. The method of claim 1 wherein the business goal is total cost of the schedule and a smaller cost is more desirable than a larger cost.

29. The method of claim 1 wherein the business goal is maximum total profit of the schedule.

30. The method of claim 1 wherein the business goal is total sale value of the schedule and a larger total sales value is more desirable than a smaller total sales value.

31. The method of claim 1 wherein the business goal is customer satisfaction and greater customer satisfaction is more desirable than lesser customer satisfaction.

32. The method of claim 1 wherein an operational goal is project completion time and smaller project completion time is more desirable than larger project completion time.

33. The method of claim 1 wherein an operational goal is resource utilization.

34. A method for determining a schedule to complete at least one project, the schedule being optimized for a goal and comprising:
breaking down the project into a set of tasks and for each task defining any fixed costs, any additional information and any constraints associated with the task;
identifying and defining, for each of the tasks, a first resource able to complete the task and for each first resource defining the time to complete the task using the first resource, any costs associated with the first resource and any additional information associated with the first resource;
identifying and defining, for at least one of the tasks, a second resource capable of completing the at least one of the tasks and for the second resource defining the time to complete the at least one of the tasks using the second resource, any costs associated with the second resource and any additional information associated with the second resource;
defining at least one goal;
generating a set of schedules containing at least one schedule, the set of schedules being feasible and each schedule comprising the set of tasks which comprises the at least one task associated with either the first resource or the second resource;
calculating the value of the at least one goal for each schedule in the set of schedules and determining the schedule with the best value for the at least one goal in the set of schedules; and
returning the schedule with the best value of the at least one goal.

35. A method for determining a schedule to complete at least one project, the schedule being optimized for a goal and comprising:
breaking down the project into a set of tasks and for each task defining any fixed costs, any additional information and any constraints associated with the task;
identifying and defining, for each of the tasks, a resource able to complete the task and for each first resource defining the time to complete the task using the first resource, any costs associated with the first resource and any additional information associated with the first resource;
identifying and defining, for at least one of the tasks, a maximum number of a resource capable of completing the at least one of the tasks and a minimum number of the resource and defining the time to complete the at least one of the tasks using the different number of available resources, any costs associated with the second resource and any additional information associated with the second resource;
defining at least one goal;
generating a set of schedules containing at least one schedule, the set of schedules being feasible and each schedule comprising the set of tasks which comprises the at least one task associated with either the first resource or the second resource;
calculating the value of the at least one goal for each schedule in the set of schedules and determining the schedule with the best value for the at least one goal in the set of schedules; and
returning the schedule with the best value of the at least one goal.

36. A computer system for creating a schedule to complete at least one project, the schedule being optimized for a business goal and comprising:
a processing unit;
a memory storage device operatively connected to the processing unit;
an input device operatively connected to the processing unit wherein the input device is operative to transmit information to the processing unit;
a display device operative for displaying data and operatively connected to the processing unit; and
a program module stored in the memory storage device operative for providing instructions to the processing unit, the processing unit responsive to the instructions of the program module, the program module operative for:
receiving, from the input device, input information comprising;
a set of tasks necessary to complete at least one project and for each of the tasks any fixed costs, any additional information and any constraints associated with the task;
the resources necessary to complete each task and for each resource the time to complete the task using the resource, any costs associated with the resource and any additional information associated with the resource;
at least one business goal;
generating a set of schedules containing at least one schedule, the set of schedules being feasible, based on any additional information and any constraints defined for each project task and any additional information associated with each resources;
calculating the value of the at least one business goal for each schedule in the set of schedules and determining the schedule with the best value for the at least one business objective in the set of schedules; and
returning the schedule with the best value for the at least one business objective.

37. The computer system of claim 35 wherein the display device is operative to display the schedule with the best value for the at least one business objective.

38. The computer system of claim 35 wherein the memory storage device is operative to store the schedule with the best value for the at least one business objective.

39. The computer system of claim 35 wherein business goal comprises a business objective.

40. The computer system of claim 35 wherein the business goal comprises a business constraint.

41. The computer system of claim 35 wherein the input information further comprises any global costs associated with the at least one project.

42. The computer system of claim 35 wherein the input information further comprises any project costs associated with the at least one project.

43. The computer system of claim 35 wherein the program module is operative to return a number of schedules with different values for the at least one business goal and allowing a user to pick one of the returned schedules.

44. The computer system of claim 42 wherein the number of schedules is a nondominated set of schedules.

45. The computer system of claim 35 wherein optimization operators are inputted using the input device and the processing unit generates schedules that are altered based on the optimization operators.

46. The computer system of claim 35 wherein the input information further comprises at least one alternative resource that can be used for one of the tasks and the time required to complete the task using the at least one alternative resource.

47. The computer system of claim 35 wherein the input information further comprises for each resource the minimum and maximum number of that resource available and the time required to complete the task for each number of resources between the minimum and maximum number.

48. The computer system of claim 35 wherein the any additional information inputted for each task comprises any precedence relationships.

49. The computer system of claim 35 wherein the processing unit, until a set or stopping conditions are met, can generate an additional set of schedules containing at least one schedule, the additional set of schedules being feasible, based on any additional information and any constraints defined for each project task and any additional information associated with each resource and calculating the value of the at least one business goal for each schedule in the additional set of schedules and determining the schedule with the value for the at least one business goal in the additional set of schedules.

50. The computer system of claim 35 wherein the input information further comprises risk information related to the at least one project and the processing unit is operative to factor the risk information into generating the set of schedules.

51. The computer system of claim 35 wherein the input information comprises a first business goal and a second goal and the processing unit is operative to calculate the value of the first business goal and the second goal for each schedule in the set of schedules and determine the schedule with the best value for the first business objective in the set of schedules and determine the schedule with the best value for the second goal in the set of schedules.

52. The computer system of claim 50 wherein the processing unit is operative to return the schedule with the best value for the first business goal in the set of schedules and the schedule with the best value for the second goal.

53. The computer system of claim 50 wherein the first business goal comprises a business objective.

54. The computer system of claim 50 wherein the first business goal comprises a business constraint.

55. The computer system of claim 50 wherein the second goal comprises a business goal.

56. The computer system of claim 50 wherein the second goal comprises a business objective.

57. The computer system of claim 50 wherein the second goal comprises a business constraint.

58. The computer system of claim 50 wherein the second goal comprises an operational goal.

59. The computer system of claim 50 wherein the second goal comprises an operational objective.

60. The computer system of claim 50 wherein the second goal comprises an operational constraint.

61. The computer system of claim 35 wherein the input information comprises a first project and a second project and the set of tasks need to complete both the first project and the second project make up the set of tasks.

62. The computer system of claim 35 wherein the business goal is total cost of the schedule and a smaller cost is more desirable than a larger cost.

63. The computer system of claim 35 wherein the business goal is maximum total profit of the schedule.

64. The computer system of claim 35 wherein the business goal is total sale value of the schedule and a larger total sales value is more desirable than a smaller total sales value.

65. The computer system of claim 35 wherein the business goal is customer satisfaction and greater customer satisfaction is more desirable than lesser customer satisfaction.

66. The computer system of claim 35 wherein an operational goal is project completion time and smaller project completion time is more desirable than larger project completion time.

67. The computer system of claim 35 wherein an operational goal is resource utilization.
